(19) United States
(12) Patent Application Publication
(10) Pub. No.: US 2010/0317227 A1
(43) Pub. Date: Dec. 16, 2010

(54) ELECTRICAL CONNECTOR ASSEMBLY WITH IMPROVED SEALING STRUCTURE

(75) Inventors: Christophe Bouchan, Bievres (FR); Philippe Beugnot, Bievres (FR)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/305,725

(22) PCT Filed: Jun. 29, 2007
(86) PCT No.: PCT/US07/15198

§ 371 Date: May 11, 2010

Related U.S. Application Data
(60) Provisional application No. 60/818,209, filed on Jun. 30, 2006.

(51) Int. Cl. H01R 13/52

(52) U.S. Cl. 439/589

(57) ABSTRACT

An electrical connector assembly (10) including a housing (20) having a plurality of terminal receiving cavities for receiving a plurality of terminal lead wires. The housing contains a primary matt seal (30) having a plurality of holes corresponding to the terminal receiving cavities and a secondary gel seal (40) adjacent to the primary seal. A cover (50) with holes similarly aligned with the terminal receiving cavities is attached to the housing, exerting a compressive force on the primary and secondary seals. The terminal lead wires pierce the secondary seal, extend through the holes in the cover, the primary and secondary seals and are removably returned in the terminal receiving cavities.

### FIELD

This invention generally relates to electrical connector assemblies, and more particularly, to electrical connector assemblies comprising a sealing structure.

### BACKGROUND

Electrical connectors that are exposed to harsh environmental conditions require a sealing structure for preventing infiltration of moisture and debris. Typically this is accomplished by providing an electrical connector assembly that includes an interface seal and wire seal.

The interface seal is generally placed at the mating end of a connector and upon complete mating with cooperating connector form a tight seal between the connectors that prevent the contamination of the electrical connector from moisture and debris. The wire seal portion of the seal connector system comprises either a matt seal or a grommet or, in some instances, a gel seal.

The matt seal comprises a flat elastomeric pad having a plurality of holes for corresponding electrical terminal leads and a cover for holding it in place. The gel seal comprising a pad made from an elastomeric material disposed at the rear of the connector assembly and requires the terminal leads to be pressed through the gel seal. By placing the cover over the matt seal, the seal is compressed and the matt seal forms a watertight interface between the lead wire of each terminal lead and the connector housing.

This type of sealing structure has several drawbacks, namely, matt seals generally give good sealing performance but are sensitive to high pressure water jet and to wire movements under water. Additionally, a matt seal is sensitive to connector reworking (several terminal insertions and removals). During insertions and removal the metal terminal wears at the internal surface of holes in the matt seal degrading the seal interface. The matt seal requires blind plug to close empty cavities which leads to high costs.

Similarly the gel seal has several problems associated with it. Although the gel seal gives good sealing performance, it is sensitive to connector reworking (several terminals insertions and removals). The gel seal pollutes the harness maker checking devices. Finally, the insertion force of the terminals through the seal is high.

With respect to the listed techniques for producing a sealed electrical assembly, the structures are costly and have several drawbacks in the practical use of these types of sealing structures.

### SUMMARY

In order to overcome the disadvantages inherent in previously known sealed electrical connector assembly circuitry, there is provided a low cost and easily manufactured method of producing these types of connector assemblies for use in harsh environments.

The present new and improved sealed electrical connector assembly combines the use of a silicon matt seal with a silicon gel pad. This combination provides an improved sealing interface between a plurality of terminal leads and the housing in which they are received.

Other objects, features and advantages of the invention will be apparent from the following detailed description taken in connection with the accompanying drawings.

### BRIEF DESCRIPTION OF THE DRAWINGS

In the course of this detailed description, the reference will be frequently made to the attached drawings in which:

FIG. 1 is a sectional view of a conventional sealed connector assembly;

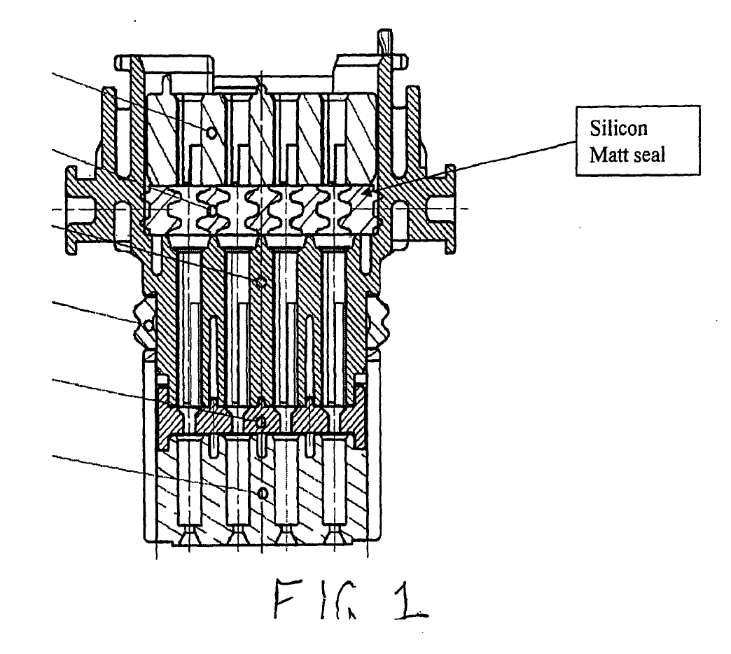

FIG. 2 is a sectional view of a conventional sealed connector assembly;

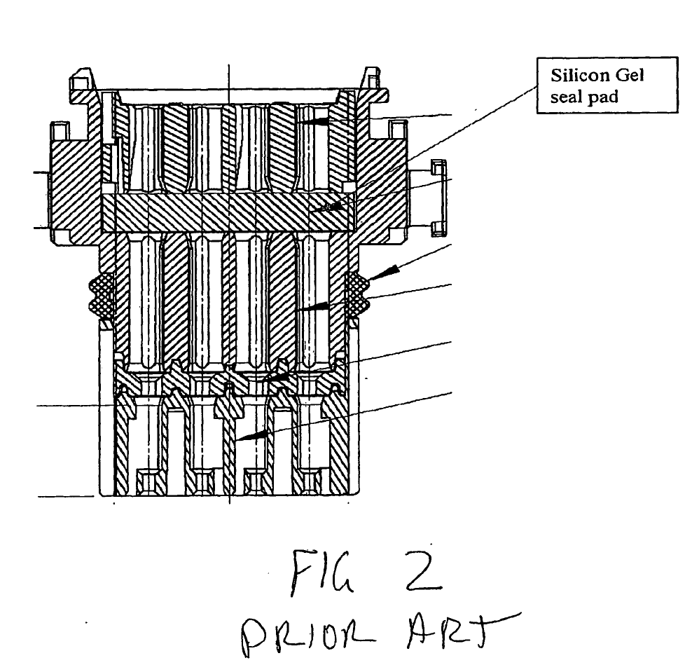

FIG. 3 is a sectional view of a conventional sealed connector assembly;

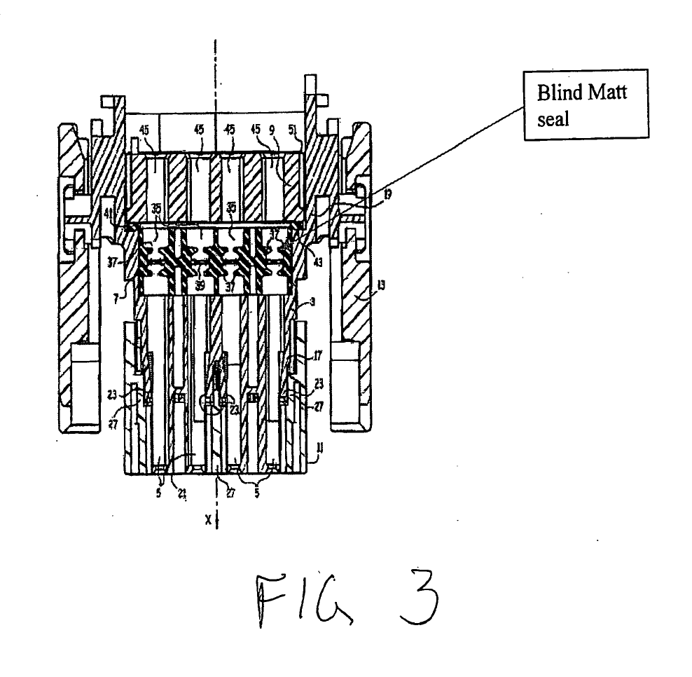

FIG. 4 is a sectional view of a sealed connector assembly according to the present invention.

### DETAILED DESCRIPTION

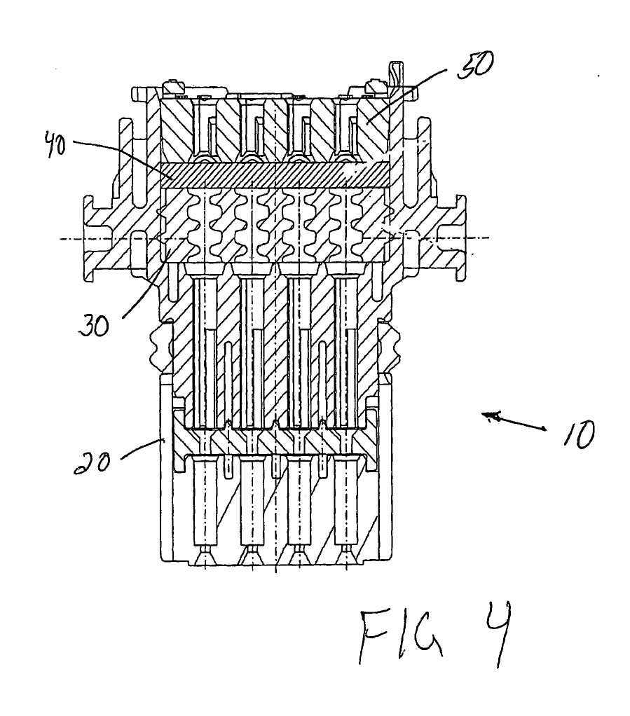

Referring to the drawings in greater detail, and first to FIG. 4, the present sealing structure is embodied in an electrical connector assembly 10. The electrical connector assembly includes a dielectric main housing 20, a plurality of terminal leads (not shown), a primary seal 30, a secondary seal 40 and a dielectric cover 50.

FIG. 4 best shows the construction of the electrical connector assembly 10. The electrical connector assembly 10 includes a dielectric housing 20, which includes a mating end for mating with a cooperating electrical connector and a back end. The main housing 20 further includes a plurality of terminal receiving cavities that removably receive the terminal leads.

Prior to the insertion of the terminal leads, the primary seal 30 is disposed on the back end of the main housing 20. The primary matt seal 30 consists of an elastomeric pad having a flat body portion with a pair of opposing surfaces. The primary seal 30 further includes a plurality of holes that correspond to the terminal leads and specific to the pattern of the terminal receiving cavities. The edge surface of the primary seal 30 conforms to the inner surface of the main housing 20. This matt seal provides strength to the sealing system, is able to withstand several terminal insertions and removals and allows low terminal insertion force.

After the primary seal 30 is assembled to the main housing 20, the secondary gel seal 40 is placed in the main housing. The secondary seal 40 consists of a silicon gel with similar opposing surfaces. The primary seal 30 and the secondary seal 40 are positioned such that adjacent opposing surfaces on the primary seal 30 and the secondary seal 40 respectively abut one another. The periphery of the secondary seal 40 is the same as the primary seal 30 such that they both conform to the inner housing surface. The secondary seal 40 is absent of any holes and therefore does not require any additional alignment. This gel seal serves to close all holes, lubricates the terminal during insertion thereby decreasing insertions force required, fully seals an empty connector without the need for use of blind plugs and protects the matt seal against high pressure water.

Once the seals 30, 40 are placed in the housing 20, the cover 50 is attached to the housing. The housing 20 and cover 50 include a cooperative locking structure to lock the housing 20 and cover 50 together. The cover 50 includes a plurality of holes that correspond to the cavity locations in the main housing 20. The holes are formed such that the terminal portion of the terminal leads can pass through the holes.

Once the cover 50 is attached to the housing 20, the individual terminal leads are inserted through the holes in the cover 50, consequently piercing the secondary gel seal 40 and passing through the secondary seal 40 and the openings in the primary matt seal 30 and finally being locked within each respective terminal receiving cavity in the housing 20.

The cover 50 and seals 30, 40 are configured so that upon attachment of the cover 50, the cover 50 imparts a compressive force on the seals 30, 40, causing them to effectively spread out and exert a sealing force against both the housing 20 and each of the wire portions of the terminal leads that pass through both the primary and secondary seals 30, 40.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. An electrical connector assembly, comprising:
a housing including a plurality of terminal receiving cavities;
a plurality of terminal leads including a terminal and lead wire received in the terminal receiving cavities of the housing;
a primary seal having a plurality of holes corresponding to said terminal receiving cavities in said housing; and
a secondary seal disposed in said housing and being adjacent to the primary seal;
a cover having holes corresponding to said terminal receiving cavities attached to said housing and exerting a compressive force on said primary and secondary seals, and
wherein each of said terminal leads is inserted though said holes in said cover and extending through said primary and secondary seals and being removably retained in said terminal receiving cavities, and
wherein the said terminal lead pierces through said secondary seal.

2. An electrical connector assembly as claimed in claim 1 wherein said primary seal is a matt seal.

3. An electrical connector assembly as claimed in claim 2 wherein said secondary seal is a gel seal.

4. An electrical connector assembly as claimed in claim 3 wherein said primary seal is a silicon matt seal and said secondary seal is a silicon gel seal.

5. An electrical connector as claimed in claim 4 or 1 wherein said secondary seal is intermediate said primary seal and said cover.

6. An electrical connector as claimed in claim 4 or 1 wherein said primary seal is intermediate said secondary seal and said cover.

7. An electrical connector as claimed in claim 3 including a lock securing said cover to said housing.
